(19) United States
(12) Patent Application Publication
(10) Pub. No.: US 2023/0207988 A1
(43) Pub. Date: Jun. 29, 2023

(54) SECONDARY BATTERY AND METHOD OF MANUFACTURING THE SAME

(71) Applicant: Murata Manufacturing Co., Ltd., Nagaokakyo-shi (JP)

(72) Inventors: Kenta EGUCHI, Nagaokakyo-shi (JP); Masahiro OTSUKA, Nagaokakyo-shi (JP)

(21) Appl. No.: 18/173,215

(22) Filed: Feb. 23, 2023

Related U.S. Application Data
(63) Continuation of application No. PCT/JP21/27898, filed on Jul. 28, 2021.

(30) Foreign Application Priority Data
Aug. 26, 2020 (JP) 2020-142746

(51) Int. Cl. H01M 50/559; H01M 50/567; H01M 50/547; H01M 50/107; H01M 50/244; H01M 10/0525

(52) U.S. Cl. CPC H01M 50/559; H01M 50/567; H01M 50/547; H01M 50/107; H01M 50/244; H01M 10/0525

(57) ABSTRACT

PA secondary battery including: an exterior body defining an internal space; an electrode assembly in the internal space of the exterior body; a terminal member electrically connected to the electrode assembly; a lead that electrically connects the terminal member and the electrode assembly; and a fixing member that fixes the lead to an inner surface of the exterior body.

### CROSS REFERENCE TO RELATED APPLICATIONS

The present application is a continuation of International application No. PCT/JP2021/027898, filed Jul. 28, 2021, which claims priority to Japanese Patent Application No. 2020-142746, filed Aug. 26, 2020, the entire contents of each of which are incorporated herein by reference.

### FIELD OF THE INVENTION

The present invention relates to a secondary battery and a method for manufacturing the secondary battery. Particularly, the present invention relates to a secondary battery including an electrode assembly composed of electrode-constituting layers including a positive electrode, a negative electrode, and a separator.

### BACKGROUND OF THE INVENTION

Secondary batteries can be repeatedly charged and discharged, and are used in various applications. For example, secondary batteries are used for mobile devices such as mobile phones, smart phones and notebook computers. Further, such secondary batteries are disclosed in Patent Document 1 and Patent Document 2.
Patent Document 1: Japanese Patent No. 5470142
Patent Document 2: Japanese Patent Application Laid-Open No. 2019-46639

### SUMMARY OF THE INVENTION

The inventors of the present application have noticed that the conventional secondary batteries have problems to be overcome, and have found a need to take measures therefor. Specifically, the inventors of the present application have found that the batteries have the following problems.

Patent Literature 1 discloses a secondary battery in which an electrode group housed in a battery container and a lid unit are connected with a lead plate interposed therebetween. In the process of for manufacturing the secondary battery, it is conceivable to increase the length of the lead plate from the viewpoints such as facilitating the electrical connection between the lead plate and the lid unit. In this case, however, it has not been easy to seal the lid unit while the lead plate is housed in the battery container. In addition, in housing the lead plate in the battery container, a load may be applied to the lid unit and/or the electrode group.

The present invention has been made in view of such problems. More specifically a main object of the present invention to provide a secondary battery that has a reduced load applied to a lead, and a method for manufacturing the secondary battery.

A secondary battery according to the present invention includes: an exterior body defining an internal space; an electrode assembly in the internal space of the exterior body; a terminal member electrically connected to the electrode assembly; a lead that electrically connects the terminal member and the electrode assembly; and a fixing member that fixes the lead to an inner surface of the exterior body.

In addition, a manufacturing method according to the present invention includes: electrically connecting a lead that is electrically connected to an electrode assembly within an interior space of an exterior body to a terminal member; and fixing the lead to an inner surface of the exterior body with a fixing member.

In the secondary battery according to the present invention, since the lead electrically connecting the terminal member and the electrode assembly is fixed to the inner surface of the exterior body, the lead fixed can be housed in the exterior body, and a load applied to the lead can be thus reduced. In addition, the method for manufacturing a secondary battery according to the present invention includes the step of fixing the lead to the inner surface of the exterior body, thus allowing the manufacture of a secondary battery in which a lead can be easily housed in an exterior body.

### BRIEF EXPLANATION OF THE DRAWINGS

FIGS. 1(a) and 1(b) schematically show an electrode-constituting layer, where FIG. 1(a) is a sectional view illustrating a planar stacked structure, and FIG. 1(b) is a sectional view illustrating a wound structure.

FIG. 2 is a schematic sectional view illustrating the configuration of a secondary battery according to an embodiment of the present invention.

FIG. 3 is a perspective view of an electrode assembly according to an embodiment of the present invention.

FIG. 4 is a sectional view schematically illustrating an exterior body cleaved by the increased internal pressure of a secondary battery.

FIGS. 5(a) and 5(b) schematically show exemplary embodiments of a secondary battery, where FIG. 5(a) is a perspective view of a button-type or coin-type secondary battery, and FIG. 5(b) is a perspective view of a rectangular secondary battery.

FIG. 6 is a schematic sectional view illustrating the configuration of a secondary battery according to another embodiment of the present invention.

FIG. 7 is a schematic sectional view illustrating the configuration of a secondary battery according to another embodiment of the present invention.

FIG. 8 is a process sectional view illustrating a process for manufacturing a secondary battery according to the present invention.

FIG. 9 is a process sectional view illustrating the process for manufacturing a secondary battery according to the present invention.

FIG. 10 is a process sectional view illustrating the process for manufacturing a secondary battery according to the present invention.

FIG. 11 is a process sectional view illustrating the process for manufacturing a secondary battery according to the present invention.

### DETAILED DESCRIPTION OF THE INVENTION

Hereinafter, a secondary battery according to an embodiment of the present invention will be described in more detail. Although the description will be made with reference to the drawings as necessary, various elements in the drawings are merely schematically and exemplarily shown for understanding of the present invention, and the appearance, the dimensional ratio, or the like can be different from those of an actual secondary battery.

The “vertical direction” and “horizontal direction” described directly or indirectly in this specification correspond to the vertical direction and horizontal direction in the drawings. Unless otherwise specified, the same reference signs or symbols denote the same members or sites, or the same semantic contents. In addition, the “sectional view” described directly or indirectly in the present specification is based on a virtual section obtained by cutting the secondary battery along the vertical direction of the electrode assembly or the electrode-constituting layer constituting the secondary battery. Similarly, the direction of a “thickness” described directly or indirectly in the present specification is based on the “vertical direction” of the electrode materials constituting the secondary battery. For example, in the case of a “secondary battery that has a thickness in a plate shape” such as a button type or a coin type, the direction of the “thickness” corresponds to the plate thickness direction of the secondary battery. The term “planar view” used in the present specification is based on a sketch drawing of an object viewed from above or below in the thickness direction. Unless otherwise specified, the same reference signs or symbols denote the same members or sites, or the same semantic contents.

The term “upper surface” used in the present specification means a surface positioned on the upper side in the vertical direction among surfaces constituting the battery, and the term “lower surface” means a surface positioned on the lower side in the vertical direction among the surfaces constituting the battery. Assuming such a typical secondary battery that has two opposed main surfaces, the term “upper surface “used in the present specification refers to one of the main surfaces, and the term “lower surface” refers to the other of the main surfaces.

[Basic Configuration of Secondary Battery]

The term “secondary battery” as used in the present specification refers to a battery that can be repeatedly charged and discharged. Accordingly, the secondary battery according to the present invention is not excessively limited by its name, and for example, an “electric storage device and the like can also be included in the subject of the present invention.

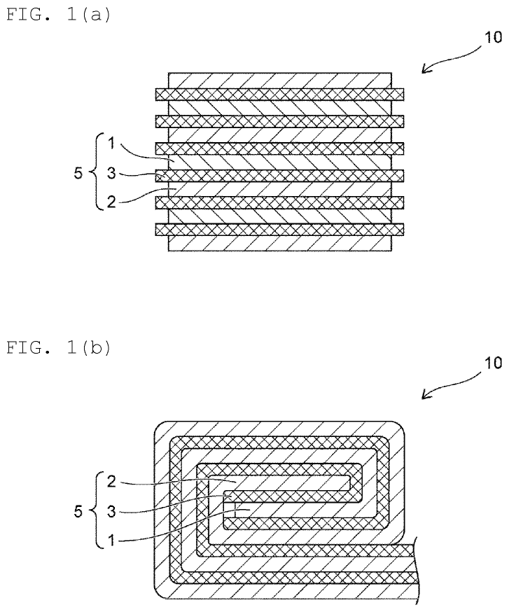

The secondary battery according to the present invention has an electrode assembly including electrode-constituting layers including a positive electrode, a negative electrode, and a separator. FIGS. 1(a) and 1(b) illustrate an electrode assembly 10. FIG. 1(a) may have a planar stacked structure that has electrode-constituting layers 5 stacked in a planar form. More specifically, the electrode assembly 10 may have a configuration in which the electrode-constituting layers 5 are stacked so as to be stacked on each other. In contrast, FIG. 1(b) may have a wound structure in which the electrode-constituting layers 5 are wound in a wound form. More specifically, FIG. 1(b) may have a wound structure in which the electrode-constituting layers 5 extending relatively long in a band form including a positive electrode, a negative electrode, and a separator disposed between the positive electrode and the negative electrode are wound in a roll form. For the secondary battery, such an electrode assembly is enclosed together with an electrolyte (for example, a nonaqueous electrolyte) in an exterior body. It is to be noted that the structure of the electrode assembly is not necessarily limited to the planar stacked structure or the wound structure, and for example, the electrode assembly may have a so-called stack-and-folding type structure in which a positive electrode, a separator, and a negative electrode are stacked on a long film and then folded.

The positive electrode 1 is composed of at least a positive electrode material layer and a positive electrode current collector. For the positive electrode, the positive electrode material layer is provided on at least one side of the positive electrode current collector, and the positive electrode material layer includes a positive electrode active material as an electrode active material. For example, for the plurality of positive electrodes in the electrode assembly, for each of the electrodes, the positive electrode material layer may be provided on both sides of the positive electrode current collector, or may be provided only on one side of the positive electrode current collector.

The negative electrode 2 is composed of at least a negative electrode material layer and a negative electrode current collector. For the negative electrode, the negative electrode material layer is provided on at least one side of the negative electrode current collector, and the negative electrode material layer includes a negative electrode active material as an electrode active material. For example, for the plurality of negative electrodes in the electrode assembly, for each of the electrodes, the negative electrode material layer may be provided on both sides of the negative electrode current collector, or may be provided only on one surface of the negative electrode current collector.

The electrode active materials included in the positive electrode 1 and the negative electrode 2, that is, the positive electrode active material and the negative electrode active material are substances directly involved in the transfer of electrons in the secondary battery, and are main substances of the positive and negative electrodes, which are responsible for charge-discharge, that is, a battery reaction. More specifically, ions are brought into the electrolyte due to “the positive electrode active material included in the positive electrode material layer” and “the negative electrode active material included in the negative electrode material layer”, and such ions move between the positive electrode and the negative electrode to transfer electrons, thereby leading to charge-discharge. The positive electrode material layer and the negative electrode material layer may be layers particularly capable of occluding and releasing lithium ions. More specifically, the secondary battery according to the present invention may be a nonaqueous electrolyte secondary battery in which lithium ions move between the positive electrode and the negative electrode through a nonaqueous electrolyte, thereby charging and discharging the battery. When lithium ions are involved in charge-discharge, the secondary battery according to the present invention corresponds to a so-called “lithium ion battery”, and the positive electrode and the negative electrode include a layer capable of occluding and releasing lithium ions.

When the positive electrode active material of the positive electrode material layer is composed of, for example, a granular material, a binder may be included in the positive electrode material layer for more sufficient contact between the particles and shape retention. Furthermore, a conductive auxiliary agent may be included in the positive electrode material layer to facilitate the transfer of electrons promoting a battery reaction. Similarly, when the negative electrode active material of the negative electrode material layer is composed of, for example, a granular material, a binder may be included for more sufficient contact between the particles and shape retention, and a conductive auxiliary agent may be included in the negative electrode material layer to facilitate the transfer of electrons promoting a battery reaction. As described above, the positive electrode material layer and the negative electrode material layer can, because of containing the multiple components, also be referred to respectively as a “positive electrode mixture layer” and a “negative electrode mixture layer”.

The positive electrode active material may be a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from a group consisting of cobalt, nickel, manganese, and iron. More specifically, in the positive electrode material layer of the secondary battery according to the present invention, such a lithium-transition metal composite oxide is preferably included as a positive electrode active material. For example, the positive electrode active material may be lithium cobaltate, lithium nickelate, lithium manganate, lithium iron phosphate, or a material obtained by replacing a part of the transition metals with another metal. Such a positive electrode active material may be included as a single species, or two or more species may be included in combination.

The binder that can be included in the positive electrode material layer is not particularly limited, and examples thereof include at least one selected from the group consisting of a polyvinylidene fluoride, a vinylidene fluoride-hexafluoropropylene copolymer, a vinylidene fluoride-tetrafluoroethylene copolymer, and a polytetrafluoroethylene. The conductive auxiliary agent that can be included in the positive electrode material layer is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives.

The thickness dimension of the positive electrode material layer is not particularly limited, and may be 1 μm to 300 μm, and is, for example, 5 μm to 200 μm. The thickness dimension of the positive electrode material layer is a thickness inside the secondary battery, and the average value of measured values at random 10 points may be employed.

The negative electrode active material may be a material that contributes to occlusion and release of lithium ions. From such a viewpoint, the negative electrode active material may be, for example, various carbon materials, oxides, and/or lithium alloys.

Examples of the various carbon materials for the negative electrode active material include graphite (natural graphite and artificial graphite), hard carbon, soft carbon, and diamond-like carbon. Particularly, graphite has high electron conductivity and excellent adhesiveness to the negative electrode current collector. Examples of the oxides for the negative electrode active material include at least one selected from the group consisting of a silicon oxide, a tin oxide, an indium oxide, a zinc oxide, and a lithium oxide. The lithium alloys for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, and La. Such an oxide may be amorphous as its structural form. This is because deterioration due to nonuniformity such as grain boundaries or defects is less likely to be caused.

The binder that can be included in the negative electrode material layer is not particularly limited, and examples thereof include at least one selected from the group consisting of a styrene butadiene rubber, a polyacrylic acid, a polyvinylidene fluoride, a polyimide-based resin, and a polyamideimide-based resin. For example, the binder included in the negative electrode material layer may be a styrene-butadiene rubber. The conductive auxiliary agent that can be included in the negative electrode material layer is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. It is to be noted that the negative electrode material layer may include therein a component derived from a thickener component (for example, a carboxymethyl cellulose) used at the time of manufacturing the battery.

The thickness dimension of the negative electrode material layer is not particularly limited, and may be 1 μm to 300 μm, and is, for example, 5 μm to 200 μm. The thickness dimension of the negative electrode material layer is a thickness inside the secondary battery, and the average value of measured values at random 10 points may be employed.

The positive electrode current collector and the negative electrode current collector used for the positive electrode and the negative electrode are members that contribute to collecting and supplying electrons generated in the electrode active material by the battery reaction. Such an electrode current collector may be a sheet-like metal member. In addition, such an electrode current collector may have a porous or perforated form. For example, the current collector may be a metal foil, a punching metal, a net, an expanded metal, or the like. The positive electrode current collector used for the positive electrode is preferably made of a metal foil containing at least one selected from the group consisting of aluminum, stainless steel, and nickel, and may be, for example, an aluminum foil. In contrast, the negative electrode current collector used for the negative electrode is preferably made of a metal foil containing at least one selected from the group consisting of copper, stainless steel, and nickel, and may be, for example, a copper foil. It is to be noted that the term “stainless steel” in the present specification refers to, for example, the stainless steel defined in “JIS G 0203 Glossary of terms used in iron and steel”, which may be an alloy steel containing chromium or containing chromium and nickel.

The thickness dimension of each of the positive electrode current collector and the negative electrode current collector is not particularly limited, and may be 1 μm to 100 μm, and is, for example, 10 μm to 70 μm. The thickness dimension of each of the positive electrode current collector and the negative electrode current collector is a thickness inside the secondary battery, and the average value of measured values at random 10 points may be employed.

The separator 3 used for the positive electrode and the negative electrode is a member provided from viewpoints such as preventing a short circuit due to contact between the positive and negative electrodes and holding the electrolyte. In other words, the separator can be considered as a member that allows ions to pass through while preventing electronic contact between the positive electrode and the negative electrode. For example, the separator is a porous or microporous insulating member, which may have the form of a membrane to the small thickness. By way of example only, a microporous membrane made of a polyolefin may be used as the separator. In this respect, the microporous membrane for use as the separator may include, for example, only a polyethylene (PE) or only a polypropylene (PP) as the polyolefin. Furthermore, the separator may be a laminate composed of a “microporous membrane made of PE” and a “microporous membrane made of PP”. The surface of the separator may be covered with an inorganic particle coating layer, and/or an adhesive layer. The surface of the separator may have adhesiveness. Further, in the present invention, the separator is not to be particularly limited by its name, and may be solid electrolytes, gel electrolytes, and/or insulating inorganic particles that have a similar function.

The thickness dimension of the separator is not particularly limited, and may be 1 μm to 100 μm, and is, for example, 2 μm to 20 μm. The thickness dimension of the separator is a thickness inside the secondary battery (particularly, the thickness between the positive electrode and the negative electrode), and the average value of measured values at random 10 points may be employed.

For the secondary battery according to the present invention, the electrode assembly 10 composed of the electrode-constituting layers 5 including the positive electrode 1, the negative electrode 2, and the separator 3 may be enclosed together with an electrolyte in an exterior body. The electrolyte can assist the movement of metal ions released from the electrodes (positive electrode and/or negative electrode). The electrolyte may be a “nonaqueous” electrolyte, such as an organic electrolyte and an organic solvent, or may be an “aqueous” electrolyte containing water. When the positive electrode and the negative electrode have a layer capable of occluding and releasing lithium ions, the electrolyte is preferably a “nonaqueous” electrolyte containing an organic electrolyte and/or an organic solvent, or the like. More specifically, the electrolyte preferably serves as a nonaqueous electrolyte. In the electrolyte, metal ions released from the electrodes (positive electrode and/or negative electrode) will be present, and the electrolyte will thus assist the movement of the metal ions in the battery reaction. It is to be noted that the electrolyte may have a form such as a liquid form or a gel form.

The nonaqueous electrolyte is an electrolyte including a solvent and a solute. A specific solvent for the nonaqueous electrolyte may contain at least a carbonate. Such carbonates may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonates include at least one selected from the group consisting of a dimethyl carbonate (DMC), a diethyl carbonate (DEC), an ethyl methyl carbonate (EMC), and a dipropyl carbonate (DPC). By way of an example only, combinations of cyclic carbonates and chain carbonates may be used as the nonaqueous electrolyte, and for example, a mixture of an ethylene carbonate and a diethyl carbonate may be used. As a specific solute for the nonaqueous electrolyte, for example, Li salts such as LiPF₆ and/or LiBF₄ may be used.

The exterior body 50 of the secondary battery is a member capable of housing or enclosing the electrode assembly 10 including the electrode-constituting layers 5 including the positive electrode 1, the negative electrode 2, and the separator 3. As will be described later, in the present invention, the exterior body 50 may be a metal exterior body that has a non-laminate configuration.

[Feature of Secondary Battery According to Present Invention]

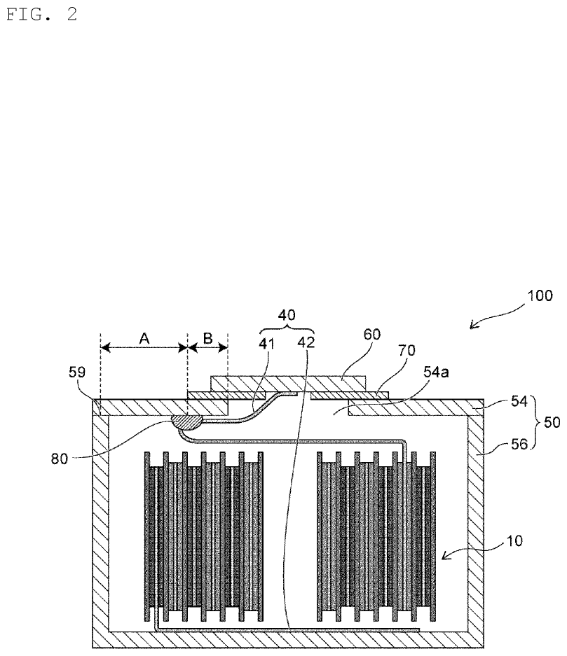

The secondary battery 100 according to the present invention includes the electrode assembly 10 described above, the exterior body 50 that has a space for housing the electrode assembly 10 therein, a terminal member 60 electrically connected to the electrode assembly 10, and a lead 40 for electrically connecting the terminal member 60 and the electrode assembly 10 (see FIG. 2).

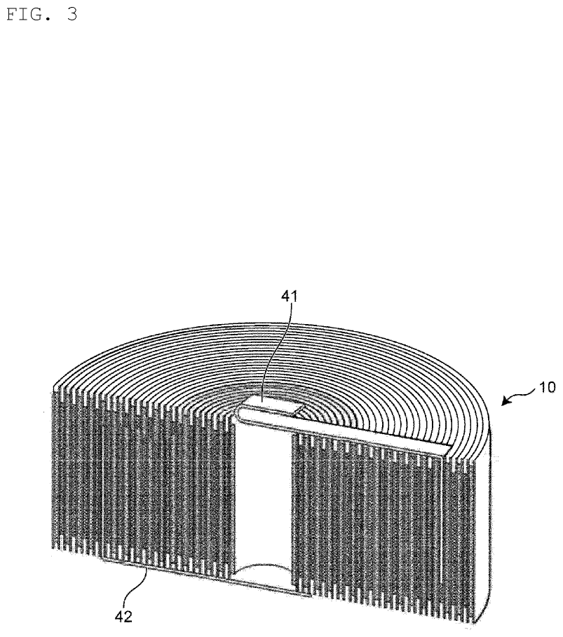

The electrode assembly 10 according to the present embodiment may have the wound-type structure described above with reference to FIG. 1(b). More specifically, the electrode assembly 10 may have a wound structure formed by winding, into a roll form, a plate-shaped structure including a positive electrode, a negative electrode, and a separator disposed between the positive electrode and the negative electrode. In the case of the wound-type electrode assembly 10, as illustrated in FIGS. 2 and 3, leads may be drawn out from the upper surface and lower surface of the electrode assembly 10. The upper-surface lead 41 drawn out from the upper surface may be electrically connected with the positive electrode of the electrode assembly 10, and the lower-surface lead 42 drawn out from the lower surface may be electrically connected with the negative electrode of the electrode assembly 10. Any material may be used for the upper-surface lead 41 and the lower-surface lead 42 as long as the material is a conductive metal, and the material may be the same as or different from the positive electrode or the negative electrode as long as the material can be electrically conducted with the positive electrode or negative electrode of the electrode assembly 10.

The exterior body 50 may be a metal exterior body that has a non-laminate configuration. In such a case, the exterior body 50 is not a laminate member including a metal sheet, a fusion layer, and a protective layer. More specifically, the exterior body 50 has a non-laminate configuration. The metal exterior body that has the non-laminate configuration preferably has a configuration including a single metal member. For example, such a metal exterior body may be a single member made of a metal such as stainless steel (SUS) and/or aluminum. The term “single metal member” as used herein means that the exterior body 50 has no so-called laminate configuration in a broad sense, and means that the exterior body 50 is a member substantially made of only a metal in a narrow sense. Thus, as long as the metal exterior body is a member substantially made of only a metal, the surface of the metal exterior body may be subjected to an appropriate surface treatment.

From the viewpoint of easily housing the electrode assembly 10, the exterior body 50 may include a first exterior body 54, which is a lid-shaped member, and a second exterior body 56, which is a cup-shaped member, as in the preferred embodiment illustrated in FIG. 2. The first exterior body 54 and the second exterior body 56 may be joined to each other by welding. It is to be noted that the “cup-shaped member” in the present specification means such a member that has a side surface corresponding to the body and a main surface (according to a typical aspect, for example, a bottom) that is continuous with the side surface, and forms a hollow therein. The “lid-shaped member” in the present specification means a member provided so as to cover such a cup-shaped member. The lid-shaped member may be, for example, a single member (typically a flat plate-shaped member) extending in the same plane. For the exterior body, the lid-shaped member and the cup-shaped member may be combined such that the outer edge of the lid-shaped member and the upper end of the side surface of the cup-shaped member fit with each other.

The first exterior body 54 as a lid-shaped member may have, at the center thereof, an opening 54a formed. Further, the terminal member 60 may be provided so as to cover the opening 54a. An insulating material 70 may be disposed between the terminal member 60 and the first exterior body 54.

The insulating material 70 is provided so as to fill the gap between the first exterior body 54 and the terminal member 60, and it can be thus understood that the insulating material 70 contributes to “sealing”. As illustrated in FIG. 2, the insulating material 70 may have a shape that follows the first exterior body 54 so as to extend up to a region outside the terminal member 60. More specifically, the insulating material 70 may be provided on the exterior body 50 so as to protrude outwards from the terminal member 60. The type of the insulating material 70 is not particularly limited as long as the insulating material exhibits an “insulating property”. Preferably, the insulating material has not only the “insulating property” but also “adhesiveness”. For example, the insulating material 70 may include a thermoplastic resin. By way of specific example only, the insulating material may include a polyolefin such as a polyethylene and/or a polypropylene.

The terminal member 60 means, in the secondary battery, an output terminal provided for connection to an external device. The terminal member 60 has the form of, for example, a flat plate shape. The flat plate-shaped terminal member 60 may be, for example, a metal plate. The material of the terminal member 60 is not particularly limited, and may contain at least one metal selected from the group consisting of aluminum, nickel, and copper. As can be seen from the preferred embodiment illustrated in FIG. 2, the terminal member 60 may have a shape that follows the first exterior body 54. More specifically, in the sectional view as illustrated, the terminal member 60, and the surface of the first exterior body 54 with the terminal member provided and the insulating material 70 may have a mutually parallel positional relationship. The shape of the terminal member 60 in a planar view is also not particularly limited, and may be, for example, a circular shape, or a rectangular shape including a quadrangular shape or the like. To the terminal member 60, the upper-surface lead 41 drawn out from the upper surface of the electrode assembly 10 may be electrically connected through the opening 54a of the first exterior body 54. More specifically the terminal member 60 is electrically connected to the upper-surface lead 41 electrically connected with the positive electrode, and may thus act as the positive electrode of the secondary battery. The electrical connection between the upper-surface lead 41 and the first exterior body 54 may be performed by, for example, laser welding.

The second exterior body 56 as a cup-shaped member has a housing space for housing the electrode assembly 10, and the above-described electrode assembly 10 may be housed in the housing space. In the preferred embodiment illustrated in FIG. 2, the second exterior body 56 may be electrically connected to the lower-surface lead 42 drawn out from the lower surface of the electrode assembly 10. More specifically the second exterior body 56 is electrically connected to the lower-surface lead 42 electrically connected with the negative electrode, and may thus act as the negative electrode of the secondary battery. The electrical connection between the lower-surface lead 42 and the second exterior body 56 and the connection between the first exterior body 54 and the second exterior body 56 may be performed by, for example, laser welding.

The lead 40 drawn out from the electrode assembly 10 is fixed to the inner surface of the exterior body 50. In this regard, the “inner surface of the exterior body” in the present specification means a surface of the exterior body that is not exposed to the outside in the finished secondary battery. In addition, the term “fixed” in the present specification means that the lead is attached so as not to move with respect to a predetermined position of the exterior body. For example, in the preferred embodiment illustrated in FIG. 2, the upper-surface lead 41 drawn out from the electrode assembly 10 may be fixed to the inner surface of the first exterior body 54. With such a configuration, as compared with a conventionally known “secondary battery including a lead connected to only an external electrode”, the upper-surface lead 41 is fixed to the first exterior body 54, and the load applied to the upper-surface lead 41 can thus also be distributed to the first exterior body 54. In particular, in the case of the wound-type electrode assembly illustrated in FIG. 1(b) or FIG. 2, when a load is applied to the lead and/or the electrode assembly, winding deviation may be caused, thereby causing a short circuit between the positive electrode and the negative electrode, and thus, it is useful to distribute the load to the first exterior body 54.

Furthermore, the upper-surface lead 41 is also fixed to the terminal member 60 in addition to the first exterior body 54, and the fixing strength can be thus enhanced as compared with a conventionally known “secondary battery including a lead connected to only tan external electrode”.

In addition, in the case of a conventionally known “secondary battery including a lead connected to only an external electrode”, if the lead is large in length, the frequency of folding is increased in housing the lead inside an exterior body, thereby causing the lead complicated to have complicated routing. In contrast, in the preferred embodiment of the present invention (see FIG. 2), the upper-surface lead 41 drawn out from the electrode assembly 10 is housed, with the lead fixed to the inner surface of the first exterior body 54. More specifically, the upper-surface lead 41 can be housed in the exterior body, with the lead shortened by the amount fixed to the first exterior body 54. In addition, the upper-surface lead 41 is positioned at an inner position of the first exterior body 54 so as not to hinder housing the upper-surface lead 41, and then fixed, thereby allowing for facilitating the routing of the lead at the time of housing the lead. It is to be noted that the length of the lead is preferably relatively small as long as the lead can be routed. The lead is shortened, thereby allowing compactification at the time of housing.

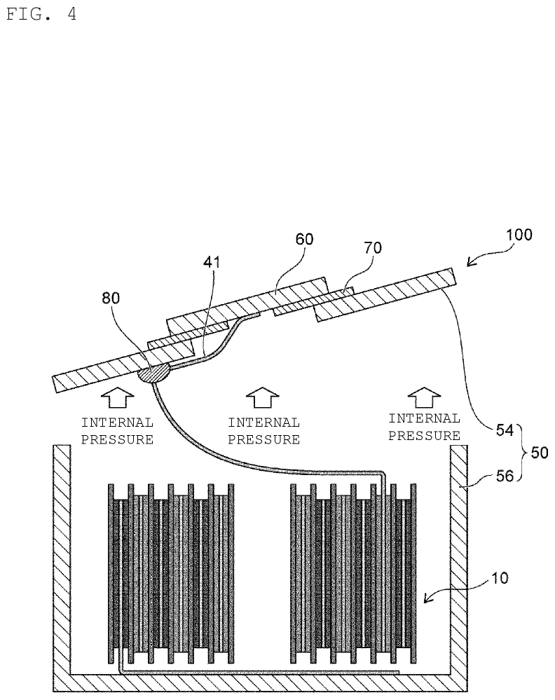

Furthermore, in a conventionally known “secondary battery including a lead connected to only an external electrode”, if the exterior is cleaved by the abnormally increased internal pressure of the exterior body, the external electrode may be detached from the lead and then scattered to the environment. In contrast, in the preferred embodiment of the present invention (see FIGS. 2 and 4), the upper-surface lead 41 is also fixed to the terminal member 60 in addition to the first exterior body 54. Accordingly, as compared with a conventionally known “secondary battery including a lead connected to only an external electrode”, the fixing strength is enhanced, and thus, if the internal pressure of the exterior body is abnormally increased, the first exterior body 54 and the terminal member 60 can be kept from being detached from the lead scattered to the environment.

The lead may be fixed with a fixing member. In the preferred embodiment illustrated in FIG. 2, the upper-surface lead 41 is preferably fixed with a fixing member 80. More specifically, in the present embodiment, the lead is preferably not fixed by means such as crimping or welding without using a fixing member. With such fixing with the fixing member 80 used, the upper-surface lead 41 and the first exterior body 54 can be firmly fixed to each other.

The fixing member 80 used for fixing the lead is preferably a member that provides adhesiveness between the exterior body and the lead. In the present specification, the term “adhesiveness” means a property that peeling is unlikely to be caused after bonding. Examples of the fixing member 80 include an adhesive containing a polyethylene and/or a polypropylene, an olefin-based adhesive, a resin-based adhesive, and a hot-melt adhesive. The fixing method with the fixing member 80 used can achieve more firmly fixing than the fixing by crimping or welding.

The fixing strength between the upper-surface lead 41 and the first exterior body 54 may be higher than the connection strength between the terminal member 60 and the upper-surface lead 41. More specifically, the fixing between the terminal member 60 fixed with the fixing member 80 used and the first exterior body 54 may be higher than the connection strength between the upper-surface lead 41 and fixing member 80 electrically connected by laser welding or the like as described above. In this regard, in the present specification, the “connection strength” means an index that indicates how much strength peels off members when the members are connected to each other. With such fixing, if the internal pressure of the exterior body is abnormally increased, the first exterior body 54 and the terminal member 60 can be kept from being detached from the lead and scattered to the environment, because the first exterior body 54 and the upper-surface lead 41 are firmly fixed to each other.

Furthermore, the fixing member 80 is preferably a member that has an insulating property. In the present specification, the term “insulating property” is a property that makes a current unlikely to flow, and means the range of 10⁶ Ω·m or more in terms of resistivity. In the preferred embodiment illustrated in FIG. 2, the upper-surface lead 41 and the first exterior body 54 are electrically insulated from each other by the fixing member 80. Furthermore, as a more preferred approach for electrically insulating the upper-surface lead 41 and the first exterior body 54, an insulating material may be provided over a part or the whole region of the inner surface of the first exterior body 54. As described above, as long as the fixing member 80 is a member that has an insulating property, the insulation between the positive electrode and the negative electrode is maintained if the upper-surface lead 41 is fixed to the first exterior body 54. It is to be noted that, in the preferred embodiment illustrated in FIG. 2, when the first exterior body 54 and the second exterior body 56 are already electrically insulated from each other, the fixing member 80 does not have to be a member that has an insulating property.

Next, additional aspects of fixing the lead will be described.

The lead may be folded and housed in the exterior body. More specifically, in the preferred embodiment illustrated in FIG. 2, the upper-surface lead 41 may be folded and housed in the housing space between the first exterior body 54 and the second exterior body 56. More specifically, the upper-surface lead 41 may be a flexible conductive member. The upper-surface lead 41 is folded and housed, thereby allowing a secondary battery that has a small size in the thickness direction.

In the preferred embodiment illustrated in FIG. 2, the position of fixing the upper-surface lead 41 is preferably located between the position of connecting the upper-surface lead 41 to the electrode assembly body 10 and the position of connecting the upper-surface lead 41 to the terminal member 60. More specifically, the first exterior body 54 is preferably fixed to an intermediate region of the upper-surface lead 41. According to such a fixing aspect, the upper-surface lead 41 can be housed in the exterior body, with the upper-surface lead 41 fixed to be shortened by the length from the position of the connection to the terminal member 60 to the position of the connection to the first exterior body 54.

In the preferred embodiment illustrated in FIG. 2, the first exterior body 54 and the second exterior body 56 are welded to each other at a welded part 59, and the length A from the position of fixing the upper-surface lead 41 and the first exterior body 54 to the welded part 59 is preferably longer than the horizontal length B between: the position of fixing the upper-surface lead 41 and the first exterior body 54; and the end of the opening 54a of the first exterior body 54. The upper-surface lead 41 and the first exterior body 54 are fixed with the fixing member 80 at such a position, thereby making it possible to reduce the influence of heat generated at the time of welding the first exterior body 54 and the second exterior body 56 on the fixing member 80.

In the preferred embodiment illustrated in FIG. 2, the upper-surface lead 41 may be fixed to the inner surface of the first exterior body 54 and a surface of the terminal member 60 exposed within the housing space of the exterior body 50. More specifically, the upper-surface lead 41 may be fixed to a back surface that is not exposed to the outside in a member constituting the secondary battery. The upper-surface lead 41 is fixed at such a position, thereby allowing the upper-surface lead 41 to be housed in the housing space between the first exterior body 54 and the second exterior body 56.

In the preferred embodiment illustrated in FIG. 2, the upper-surface lead 41 may be fixed to the inner surface of the first exterior body 54 through the opening 54a of the first exterior body 54. Such a fixing method is employed, thereby allowing the upper-surface lead 41 and the terminal member 60 to be appropriately electrically connected with each other.

In the preferred embodiment illustrated in FIG. 2, the upper-surface lead 41 and the first exterior body 54 are fixed at one site, but the present invention is not limited to this example, and multiple fixing positions may be provided. The upper-surface lead 41 is fixed at multiple positions in this manner, thereby allowing the fixing strength to be increased.

In the preferred embodiment illustrated in FIG. 2, the upper-surface lead 41 is fixed to the first exterior body 54, but is not limited to this example, and may be fixed to the second exterior body 56. If the upper-surface lead 41 is fixed at such a position, the load applied to the lead can be reduced.

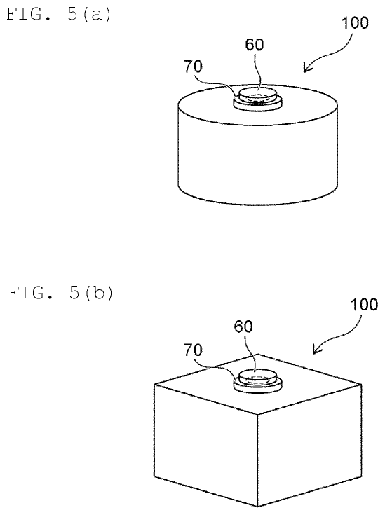

Further, according to this aspect, the overall shape of the secondary battery in a planar view is a substantially circular shape. More specifically, the secondary battery 100 has a button type or a coin type in terms of outer shape (refer to FIG. 5(a)). The present invention is, however, not necessarily limited thereto. For example, a rectangular secondary battery may be used (see FIG. 5(b)). More specifically, the shape of the secondary battery 100 in a planar view is not limited to a circular shape, and the secondary battery 100 may have a quadrangular shape, a rectangular shape, or the like.

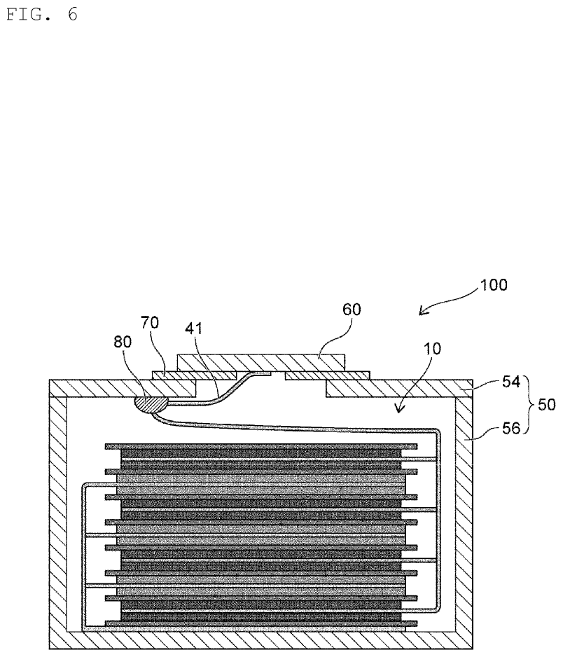

Next, another embodiment of the present invention will be described with reference to FIG. 6. FIG. 6 is a schematic sectional view illustrating the configuration of a secondary battery according to another embodiment of the present invention. It is to be noted that description of the same configuration as that of the above-described embodiment will be omitted.

An electrode assembly 10 according to the present embodiment may have the stacked-type structure described above with reference to FIG. 1(a). More specifically, the electrode assembly 10 may have a stacked structure that have plate-shaped structures stacked on one another, each including a positive electrode, a negative electrode, and a separator disposed between the positive electrode and the negative electrode. In this case, leads may be drawn out from both side surfaces of the electrode assembly 10, and in the preferred embodiment illustrated in FIG. 6, the upper-surface lead 41 drawn out from the right side surface toward the upper surface and the lower-surface lead 42 drawn out from the left side surface toward the lower surface may be provided. The upper-surface lead 41 may be electrically connected with the positive electrode of the electrode assembly 10, and the lower-surface lead 42 may be electrically connected with the negative electrode of the electrode assembly 10.

Further, in the preferred embodiment illustrated in FIG. 6, the upper-surface lead 41 may be fixed to the first exterior body 54. As described above, when the upper-surface lead 41 is fixed to the first exterior body 54, the load applied to the upper-surface lead 41 can also be distributed to the first exterior body 54. Furthermore, the upper-surface lead 41 is fixed to the terminal member 60 in addition to the first exterior body 54, thus allowing the fixing strength to be increased. Furthermore, the upper-surface lead 41 can be housed in the exterior body with the upper-surface lead 41 shortened by the amount fixed to the first exterior body 54. In addition, the upper-surface lead 41 is positioned at an inner position of the first exterior body 54 so as not to hinder housing the upper-surface lead 41, and then fixed, thereby allowing for facilitating the routing of the lead at the time of housing the lead. Furthermore, if the internal pressure of the exterior body is abnormally increased, the first exterior body 54 and the terminal member 60 can be kept from being detached from the lead and scattered to the environment.

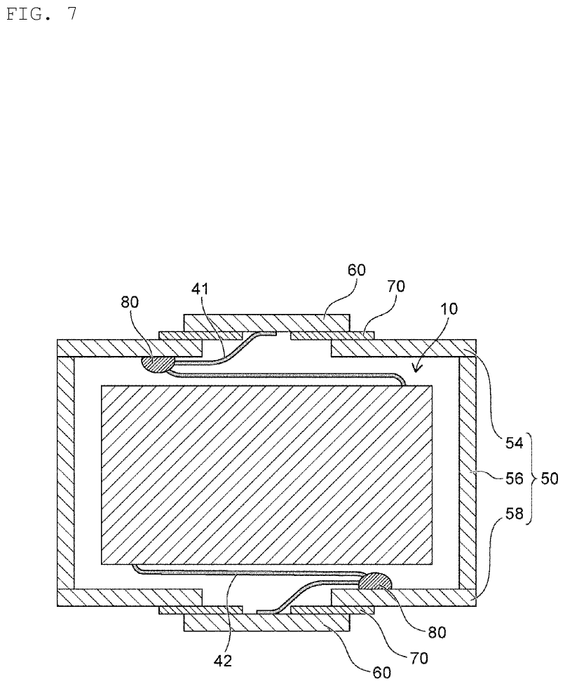

Next, another embodiment of the present invention will be described with reference to FIG. 7. FIG. 7 is a schematic sectional view illustrating the configuration of a secondary battery according to another embodiment of the present invention. It is to be noted that description of the same configuration as that of the above-described embodiment will be omitted.

In the preferred embodiment illustrated in FIG. 7, an exterior body 50 may include a first exterior body 54 and a third exterior body 58, which are lid-shaped members, and a second exterior body 56, which is a cylindrical member. The first exterior body 54 may seal the upper surface of the second exterior body 56, and the third exterior body 58 may seal the lower surface of the second exterior body 56. Further, from the viewpoint of manufacturing cost, the first exterior body 54 and the third exterior body 58 may have the same shape or different shapes. The first exterior body 54 and the third exterior body 58 may be welded to the second exterior body 56 by laser welding.

In the preferred embodiment illustrated in FIG. 7, an upper-surface lead 41 drawn out from the electrode assembly 10 may be fixed to the inner surface of the first exterior body 54 with a fixing member 80. Furthermore, a lower-surface lead 42 drawn out from the electrode assembly 10 may be fixed to the inner surface of the third exterior body 58 with the fixing member 80. According to such an embodiment, in addition to the upper-surface lead 41 described in the above-described embodiment, the lower-surface lead 42 is also fixed to the third exterior body 58, thus allowing the load applied to the lower-surface lead 42 to be also distributed to the third exterior body 58. Furthermore, the lower-surface lead 42 is fixed to the terminal member 60 in addition to the third exterior body 58, thus allowing the fixing strength to be enhanced. Furthermore, the lower-surface lead 42 can be housed in the exterior body with the upper-surface lead 41 shortened by the amount fixed to the third exterior body 58. In addition, the lower-surface lead 42 is positioned at an inner position of the third exterior body 58 so as not to hinder housing the lower-surface lead 42, and then fixed, thereby allowing for facilitating the routing of the lead at the time of housing the lead. Furthermore, if the internal pressure of the exterior body is abnormally increased, the third exterior body 58 and the terminal member 60 can be kept from being detached from the lead and scattered to the environment.

[Feature of Method for Manufacturing Secondary Battery According to Present Invention]

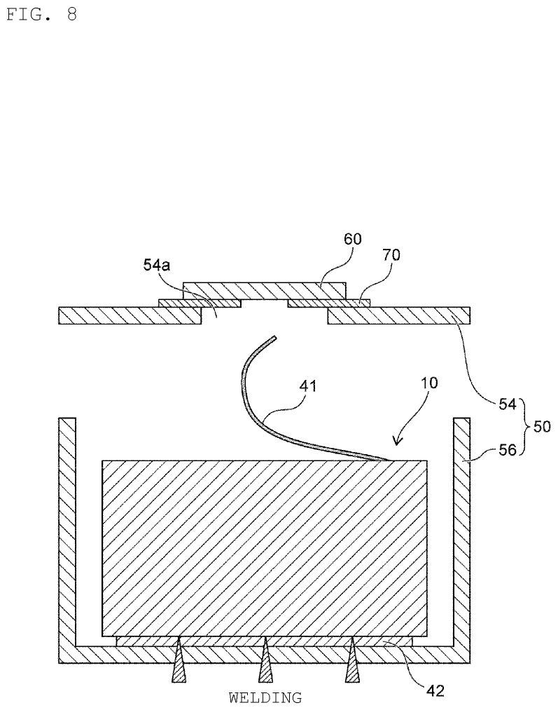

Next, a method for manufacturing the secondary battery according to the present invention will be described with reference to FIGS. 8 to 11. FIGS. 8 to 11 are process sectional views illustrating a process for manufacturing a secondary battery according to the present invention. It is to be noted that the method described below considered by way of example only, and the method for manufacturing a secondary battery according to an embodiment of the present invention is not to be considered limited to the following method.

First, an electrode assembly 10 is manufactured by stacking or winding electrode-constituting layers including a positive electrode, a negative electrode, and a separator disposed between the positive electrode and the negative electrode, and drawing leads electrically connected respectively to the positive electrode and the negative electrode. According to the present embodiment, the upper-surface lead 41 may be drawn out toward the upper surface of the electrode assembly, and the lower-surface lead 42 may be drawn out toward the lower surface thereof. Then, an electrolyte is housed together with the manufactured electrode assembly 10 in a second exterior body 56, which is a cup-shaped member (see FIG. 8). In this case, the lower-surface lead 42 of the electrode assembly 10 and the second exterior body 56 may be electrically connected by laser welding. It is to be noted that the electrical connection between the lower-surface lead 42 and the second exterior body 56 is not limited to laser welding, and for example, a conductive adhesive or the like may be used. Thus, the electrode assembly 10 is housed in the second exterior body.

Next, a sealing structure for sealing the upper surface of the second exterior body 56 is prepared. The sealing structure for use in the present embodiment may include: a first exterior body 54 with an opening 54a; a terminal member 60 that covers the opening 54a and acts as an external terminal; and an insulating material 70 with insulating and adhesive properties, provided so as to fill the gap between the terminal member 60 and the first exterior body 54. More specifically, the terminal member 60 may be bonded to the first exterior body 54 with adhesive the insulating material 70. In this manner, the sealing structure for sealing the upper surface of the second exterior body 56 is manufactured.

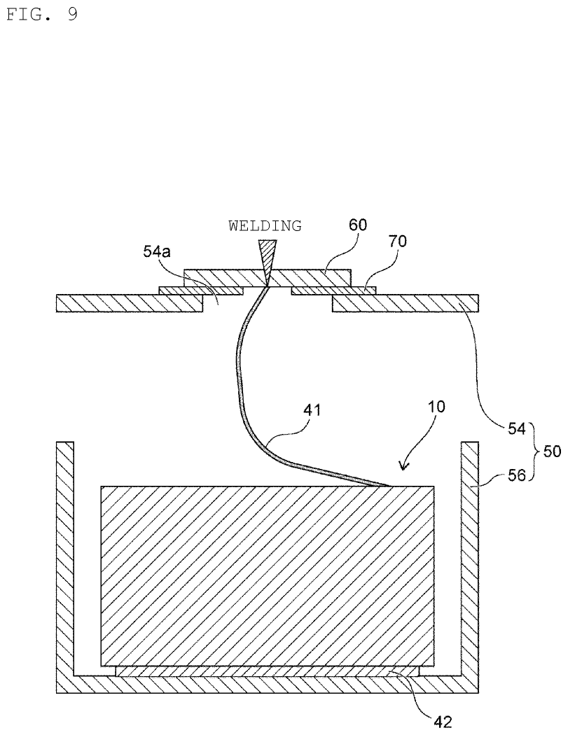

Next, the lead electrically connected to the electrode assembly is electrically connected to the terminal member. In the preferred embodiment illustrated in FIG. 9, the upper-surface lead 41 drawn out from the upper surface of the electrode assembly 10 may be electrically connected to the terminal member 60 through the opening 54a of the first exterior body 54. This electrical connection may be performed by, for example, laser welding. It is to be noted that the electrical connection is not limited to laser welding, and for example, a conductive adhesive or the like may be used. In this manner, the electrode assembly 10 and the terminal member 60 are electrically connected with the lead interposed therebetween.

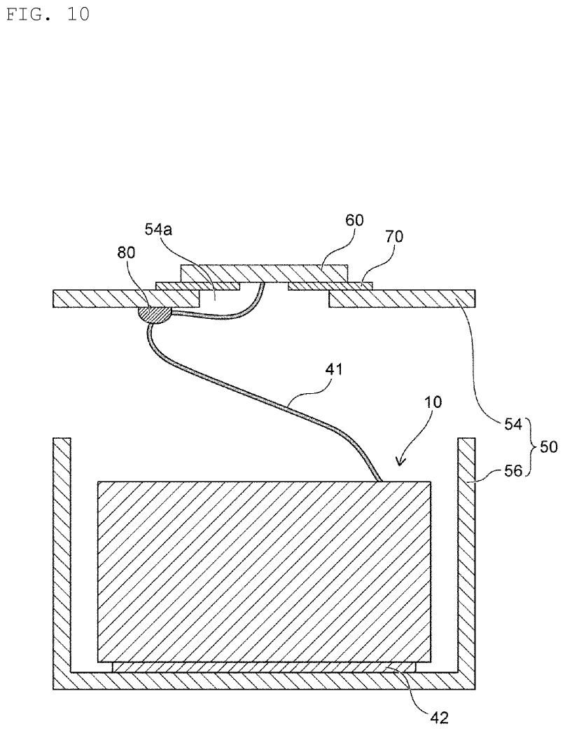

Next, the lead is fixed to the inner surface of the exterior body. In the preferred embodiment illustrated in FIG. 10, the upper-surface lead 41 may be fixed to the inner surface of the first exterior body 54. For fixing the upper-surface lead 41 and the first exterior body 54, a fixing member 80 with insulating and adhesive properties may be used. The upper-surface lead 41 and the first exterior body 54 are fixed with the use of the fixing member 80, thereby firmly fixing the upper-surface lead 41 to the first exterior body 54, and electrically insulating the upper-surface lead 41 and the first exterior body 54 from each other. It is to be noted that while the aspect of fixing the upper-surface lead 41 to the inner surface of the first exterior body 54 has been described in the present embodiment, the present invention is not limited to this example, and for example, the upper-surface lead 41 may be fixed to the inner surface of the second exterior body 56.

In addition, the position of the fixing member 80 provided is preferably close to the opening 54a of the first exterior body 54. More specifically, as illustrated in FIG. 2, the length A from the position of fixing the upper-surface lead 41 and the first exterior body 54 to the welded part 59 is preferably longer than the horizontal length B between: the position of fixing the upper-surface lead 41 and the first exterior body 54; and the end of the opening 54a of the first exterior body 54. By providing the fixing member 80 at such a position, the fixing member 80 is disposed at the position away from the welded part 59, and thus, the influence on the fixing member 80 can be reduced, if laser welding is performed for the first exterior body 54 and the second exterior body 56 as will be described later.

In addition, the fixing between the terminal member 60 fixed with the fixing member 80 used and the first exterior body 54 may be higher than the connection strength between the upper-surface lead 41 and fixing member 80 electrically connected by laser welding or the like as described above. With such fixing, if the internal pressure of the exterior body is abnormally increased, the first exterior body 54 and the terminal member 60 can be kept from being detached from the lead and scattered to the environment, because the first exterior body 54 and the upper-surface lead 41 are firmly fixed to each other.

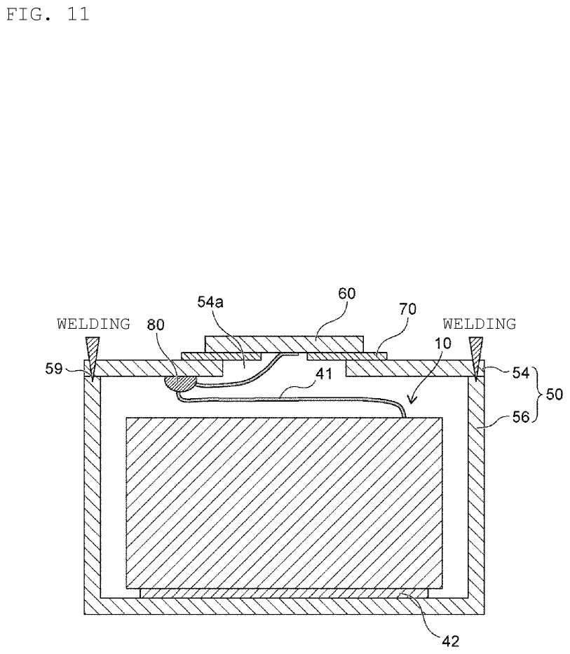

Next, as illustrated in FIG. 11, the upper-surface lead 41 is folded and then housed in the second exterior body 56. In this regard, in folding and then housing the upper-surface lead 41, because the upper-surface lead 41 is fixed to the first exterior body 54, the load applied to the upper-surface lead 41 can be also distributed to the first exterior body 54, and the load can be reduced. In addition, the lead 40 is also fixed to the terminal member 60 in addition to the first exterior body 54, thus allowing the fixing strength to be enhanced. Furthermore, the upper-surface lead 41 can be housed in the exterior body with the upper-surface lead 41 shortened by the amount fixed to the first exterior body 54. In addition, the upper-surface lead 41 is positioned at an inner position of the first exterior body 54 so as not to hinder housing the upper-surface lead 41, and then fixed, thereby allowing for facilitating the routing of the lead at the time of housing the lead.

Then, the first exterior body 54 is mounted on the upper surface of the second exterior body 56, and the first exterior body 54 and the second exterior body 56 are attached to each other. The attachment may be performed by, for example, laser welding. It is to be noted that the approach for attaching the first exterior body 54 and the second exterior body 56 is not limited to laser welding, and for example, an adhesive may be used. For electrically connecting the first exterior body 54 and the second exterior body 56 to each other, a conductive adhesive may be used. In addition, for electrically insulating the first exterior body 54 and the second exterior body 56 from each other, an insulating adhesive may be used.

As described above, the method for manufacturing a secondary battery according to the present invention includes the connecting step of electrically connecting the lead electrically connected to the electrode assembly, to the terminal member, and the fixing step of fixing the lead to the inner surface of the exterior body. Then, the secondary battery manufactured according to the present embodiment has the lead fixed to the exterior body, thus allowing the load applied to the lead to be also distributed to the exterior body, and allowing the load to be reduced. The lead is also fixed to the terminal member in addition to the exterior body, thus allowing the fixing strength to be enhanced. Furthermore, the lead can be housed in the exterior body with the lead shortened by the amount fixed to the first exterior body, and the housing can be simplified. Further, the lead is positioned at an inner position of the exterior body so as not to hinder housing the lead, and then fixed, thereby allowing for facilitating the routing of the lead at the time of housing the lead. Furthermore, if the internal pressure of the exterior body is abnormally increased, the exterior body and the terminal member can be kept from being detached from the lead and scattered to the environment.

It is to be noted that embodiments disclosed herein are considered by way of illustration in all respects, and not considered as a basis for restrictive interpretations. Accordingly, the technical scope of the present invention is not to be construed only by the embodiments mentioned above, but is defined based on the description of the claims. In addition, the technical scope of the present invention encompasses meanings equivalent to the claims and all modifications within the scope of the claims.

The secondary battery according to the present invention can be used in various fields in which battery use or power storage is assumed. By way of example only, the secondary battery according to the present invention can be also used in the fields of electricity, information, and communication in which mobile devices and the like are used (for example, electric and electronic device fields or mobile device fields including mobile phones, smartphones, notebook computers and digital cameras, activity meters, arm computers, electronic paper, wearable devices, or small electronic machines such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical device fields such as earphone hearing aids), pharmaceutical applications (fields such as dosage management systems), IoT fields, space and deep sea applications (for example, the fields of a space probe and a submersible), and the like.

### DESCRIPTION OF REFERENCE SYMBOLS

1: Positive electrode
2: Negative electrode
3: Separator
5: Electrode-constituting layer
10: Electrode assembly
40: Lead
41: Upper-surface lead
42: Lower-surface lead
50: Exterior body
54: First exterior body
54a: Opening
56: Second exterior body
58: Third exterior body
59: Welded part
60: Terminal member
70: Insulating material
80: Fixing member
100: Secondary battery

1. A secondary battery comprising:
an exterior body defining an internal space;
an electrode assembly in the internal space of the exterior body;
a terminal member electrically connected to the electrode assembly;
a lead that electrically connects the terminal member and the electrode assembly; and
a fixing member that fixes the lead to an inner surface of the exterior body.

2. The secondary battery according to claim 1, wherein the fixing member is a member that provides adhesiveness between the exterior body and the lead.

3. The secondary battery according to claim 1, wherein the fixing member is a member that has an insulating property.

4. The secondary battery according to claim 1, wherein lead is fixed to the inner surface of the exterior body and a surface of the terminal member exposed within the internal space of the exterior body.

5. The secondary battery according to claim 1, wherein a fixing position of the fixing member is between a position where the lead is connected to the electrode assembly and a position where the lead is connected to the terminal member.

6. The secondary battery according to claim 1, wherein the lead is folded and housed in the exterior body.

7. The secondary battery according to claim 1, wherein the lead is fixed to the inner surface of the exterior body at at least one position.

8. The secondary battery according to claim 1, wherein a fixing strength between the lead and the exterior body is higher than a connection strength between the terminal member and the lead.

9. The secondary battery according to claim 1, wherein the exterior body comprises a first exterior body that is a lid-shaped member and a second exterior body that is a cup-shaped member, and
the lead is fixed to at least an inner surface of the first exterior body or an inner surface of the second exterior body.

10. The secondary battery according to claim 1, wherein the exterior body comprises a first exterior body that is a first lid-shaped member, a second exterior body that is a cylindrical member, and a third exterior body that is a second lid-shaped member, and
the lead is fixed to at least any one of an inner surface of the first exterior body, an inner surface of the second exterior body, and an inner surface of the third exterior body.

11. The secondary battery according to claim 9, wherein the first exterior body defines an opening, and
the lead is fixed to the inner surface of the first exterior body.

12. The secondary battery according to claim 9, wherein a welded part welds the first exterior body and the second exterior body to each other, and
a length between the welded part and a fixing position of the fixing member is larger than a length between the fixing position and an end of the opening of the first exterior body.

13. The secondary battery according to claim 1, wherein the electrode assembly includes a positive electrode and a negative electrode capable of occluding and releasing lithium ions.

14. A method of manufacturing a secondary, the method comprising:
electrically connecting a lead that is electrically connected to an electrode assembly within an interior space of an exterior body to a terminal member; and
fixing the lead to an inner surface of the exterior body with a fixing member.

15. The method for manufacturing a secondary battery according to claim 14, wherein the lead is fixed to the inner surface of the exterior body with the fixing member such that a fixing strength thereof is greater that a strength of the connection of the lead to the terminal member.

16. The method for manufacturing a secondary battery according to claim 14, wherein the fixing member is a member that provides adhesiveness between the exterior body and the lead.

17. The method for manufacturing a secondary battery according to claim 14, wherein the fixing member is a member that has an insulating property.

18. The method for manufacturing a secondary battery according to claim 14, wherein lead is fixed to the inner surface of the exterior body and a surface of the terminal member exposed within the internal space of the exterior body.

19. The method for manufacturing a secondary battery according to claim 14, wherein a fixing position of the fixing member is between a position where the lead is connected to the electrode assembly and a position where the lead is connected to the terminal member.

20. The method for manufacturing a secondary battery according to claim 14, further comprising folding and housing the lead in the exterior body.
